(19) United States
(12) Patent Application Publication
(10) Pub. No.: US 2011/0097688 A1
(43) Pub. Date: Apr. 28, 2011

(54) IMPLANT FOR FIXING DENTAL PROSTHESES

(76) Inventor: Alberto Rebaudi, Genova (IT)

(21) Appl. No.: 12/997,184

(22) PCT Filed: Jun. 8, 2009
(86) PCT No.: PCT/EP2009/004093

§ 371 Date: Dec. 9, 2010

(30) Foreign Application Priority Data
Jun. 11, 2008 (IT) GE2008A000054

(51) Int. Cl. A61C 8/00

(52) U.S. Cl. 433/174

(57) ABSTRACT

An implant for fixing dental prostheses, such as dental crowns, bridges, dentures or the like, including a support to be screwed into a receptacle prepared in the jawbone. The implant has a stump pin that is associated with the free end of the support; the support includes at least two portions: an apex portion, provided with a thread suitable to penetrate into the jawbone and provided with vertical slots for preventing rotation and for facilitating any removal, and a crown portion provided with annular micro-notches or micro-threads. The implant is mated to the stump pin conically, i.e., a male cone in the stump mates with friction with a female cone in the implant. This system has a slot that mates with a tooth to ensure an unambiguous mating position. In larger diameters, where there is enough space, there is also a male and female hexagon.

The present invention relates to an implant for fixing dental prostheses. Implants of this kind are provided in the jawbone of a patient and are used as an artificial root in order to fix dental prostheses, such as for example dental crowns, bridges or dentures, in the oral cavity of a patient as a replacement for one or more fallen natural teeth.

Dental implants are known which essentially consist of a fixing support, of a stump pin and a cap, as described for example in Italian patent application No. GE2000A000140. The fixing support has a partly cylindrical and partly frustum-like elongated shape and is provided with a perimetric thread. It is screwed into a cavity provided for this purpose in the jawbone of the patient. The stump pin is then fixed to the side of the fixing support that is oriented toward the oral cavity of the patient. The cap is fitted onto the part of the stump pin that protrudes beyond the gum in the oral cavity and facilitates the taking of the impression and the construction of the prosthesis.

Italian patent application No. GE2005A000069, to Alberto Rebaudi, discloses a dental implant of the type described above, which also allows to align the stump pin with respect to the fixing support and the cap with respect to the pin, and therefore the cap with respect to the fixing support, in an unambiguous, preset and repeatable position. The content of the document cited above is understood to be included in the present application.

Conventional dental implants have drawbacks.

Due to the frustum-like shape of the fixing support of conventional implants, there is the danger of overloading the jawbone around the implant during the screwing-in and/or first loading of the implant. Especially as regards the crest region, there is the danger of destroying or damaging the bone due to excessive compression, which can cause avascular necrosis. Bone matter is lost and the strength of the implant is reduced. Also, directly after the procedure, the implant cannot be subjected to loads, because of the bone microfractures caused by traumatic screwing. For first loading it is necessary to wait through the bone healing step, thus influencing the overall period of time for providing prostheses.

The loss of bone matter around the implant in the region of the crest causes a further problem. One weak point of every implant is the region that connects the gum and the implant itself. After the procedure, during healing, the gum surrounds the part of the implant that may emerge slightly above the crest of the jawbone and arranges itself around the stump in order to protect the bone against the bacteria of the oral flora. Due to the loss of bone matter, the risk of the bone being penetrated by bacteria of the oral cavity increases considerably. Accordingly, the risk of inflammations and of a further loss of bone matter increases. The support for the implant is lost, the stability of the implant is decreased, and the implant is in danger. The possibility to integrate the implant in the bone and the lifespan of the implant may decrease.

The problem described above is also aesthetic. Due to the loss of bone matter around the implant in the region of the crest of the bone, there is the risk that the gum might slip, thus leaving undesirably exposed part of the implant. Also, after a healing period, the implants integrate within the bone. For this reason, any removal thereof by applying an opposite torque is difficult if not impossible. The only known solution is to mill the surrounding bone, a situation that often entails severe aesthetic and functional damage due to loss of supporting tissue.

Another problem of conventional implants is that building the prosthesis on implants is currently a laborious and often difficult procedure.

One of the problems is due to the fact that most implants have, in the connection between the stump and the implant, a rotation-preventing member that has a polygonal cross-section, for example a hexagonal or triangular one. This causes several possibilities of error, especially when one has to provide a prosthesis for several teeth with many pillars.

The number of possible positions in the case of three implants with hexagonal connection is 3×6=18 possibilities, and in the case of ten implants it is 10×6=60.

All these possibilities are a potential source of error, which makes the procedure not impossible but slower and more expensive due to the need to often perform several position tests and to the need of individual and asymmetric stump shapes, and often entails the need to provide individual keys for correct insertion.

The aim of the present invention is to provide an implant for dental prostheses that overcomes the drawbacks cited above.

An object of the present invention is to provide an implant for dental prostheses, such as for example dental crowns, bridges or dentures, that prevents or reduces the destruction or damage of the bone matter around the implant, especially in the region of the crest of the jawbone, during the screwing process and/or during first loading.

A further object of the present invention is to provide an implant for dental prostheses that is immediately stable.

A further object is to provide an implant for dental prostheses that prevents the gum from slipping and leaving part of the implant exposed.

A further object is to provide an implant that, if necessary, is easier to remove even after osteointegration has occurred.

A further object is to provide an implant for dental prostheses that allows to provide prostheses in a shorter overall time and more cheaply.

This aim and these and other objects that will become better apparent hereinafter are achieved by an implant for fixing dental prostheses, such as dental crowns, bridges, dentures or the like, comprising a support that is suitable to be screwed into a receptacle prepared in the jawbone so as to have a free end, a stump pin that is associated with said free end in order to support said prostheses, characterized in that said support comprises at least two portions: an apex portion, provided with a thread suitable to penetrate into the jawbone, and a crown portion, provided with annular micro-notches or a narrower thread.

Further characteristics and advantages will become better apparent from the description of preferred but not exclusive embodiments of the invention, illustrated by way of non-limiting example in the accompanying drawings, wherein:

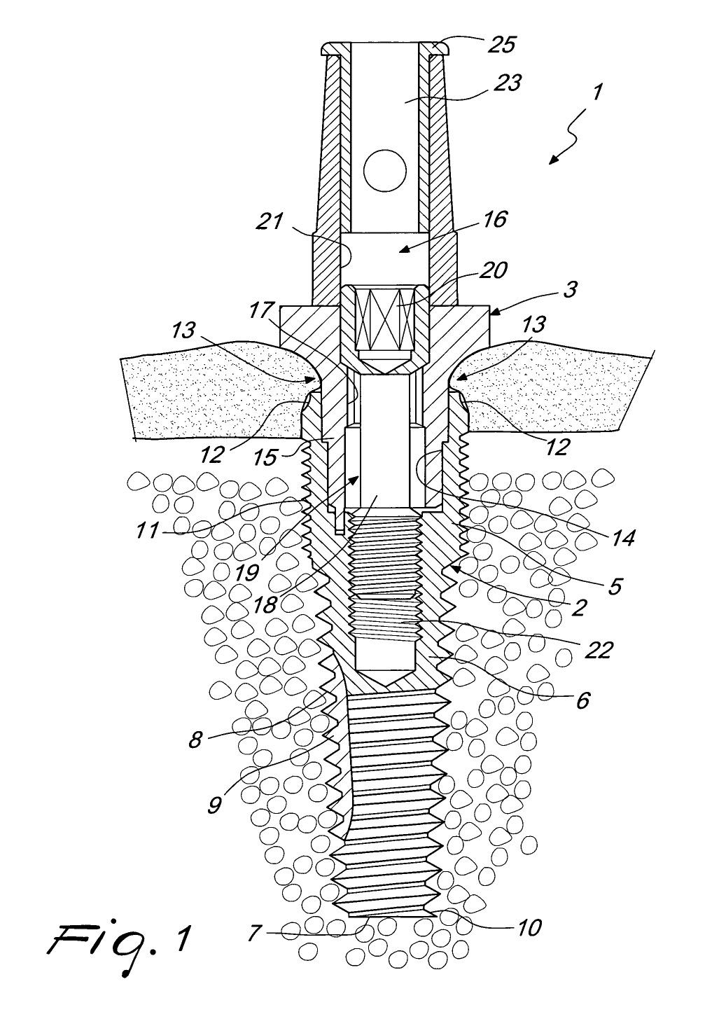

FIG. 1 is a partially sectional side view of the implant according to the present invention;

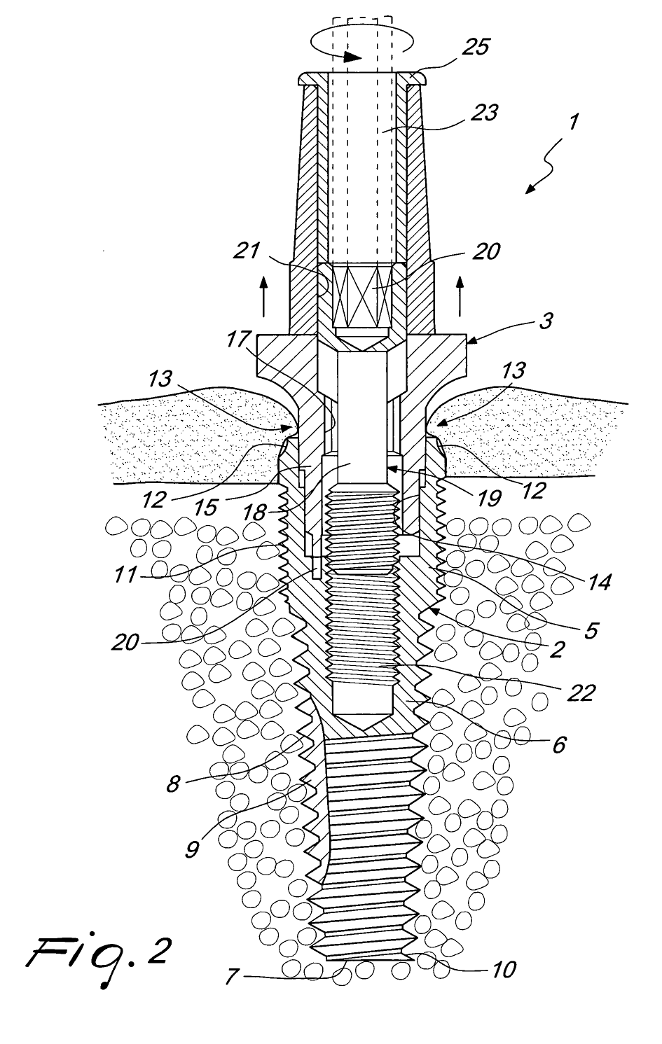

FIG. 2 is a partially sectional side view of the implant of FIG. 1, illustrating the effect of extraction by means of the screw;

FIG. 3 is a partially sectional side view of the implant, which also shows the cap;

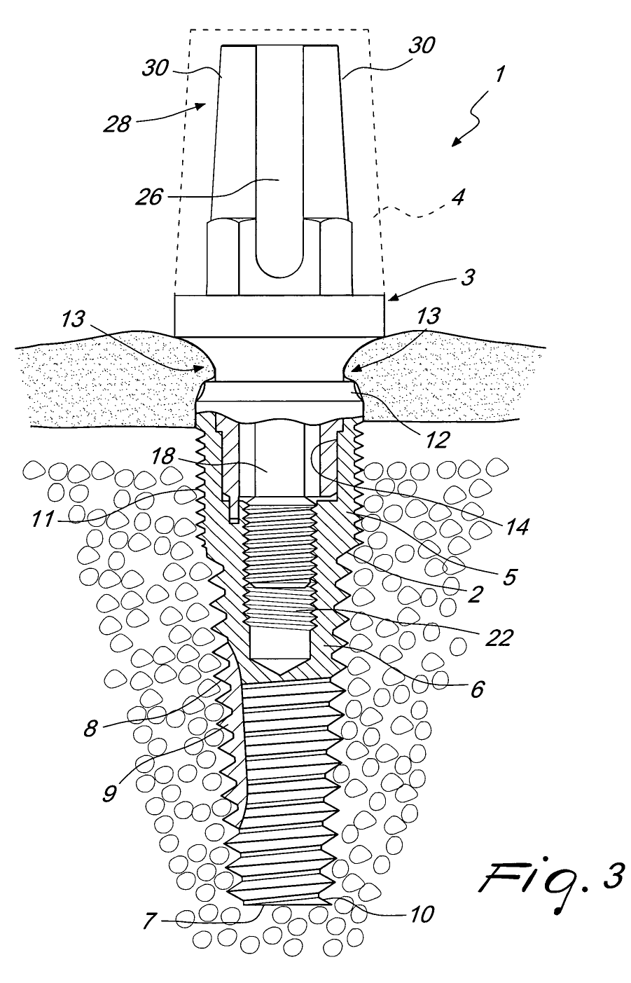

FIG. 4 is a perspective view of the stump pin;

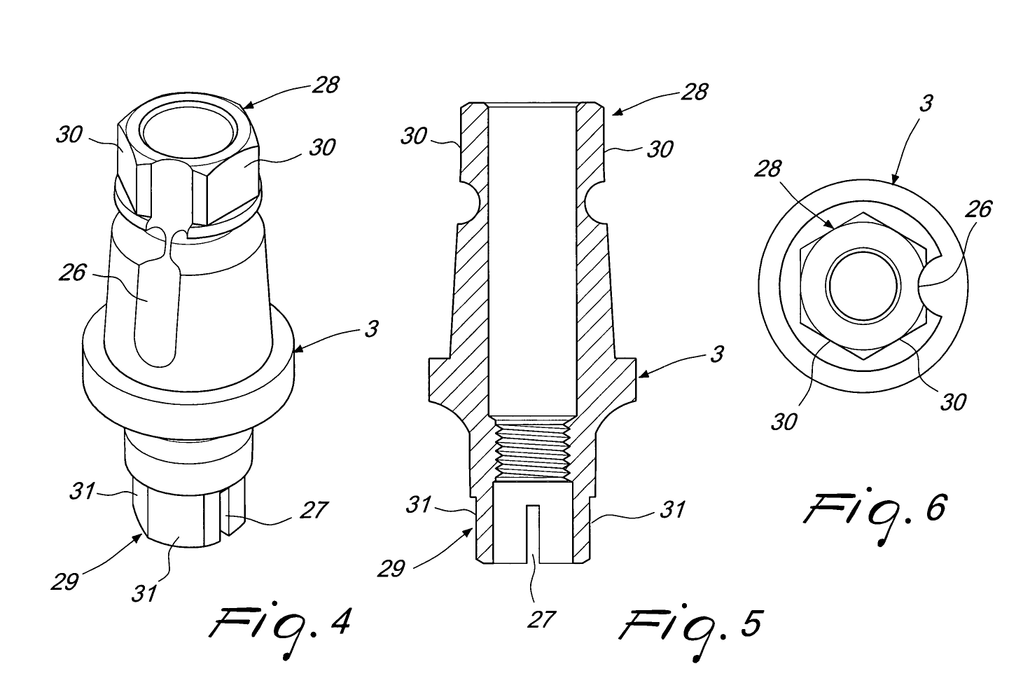

FIG. 5 is a sectional view of the stump pin;

FIG. 6 is a view of the stump pin taken from the side that protrudes into the oral cavity of the patient;

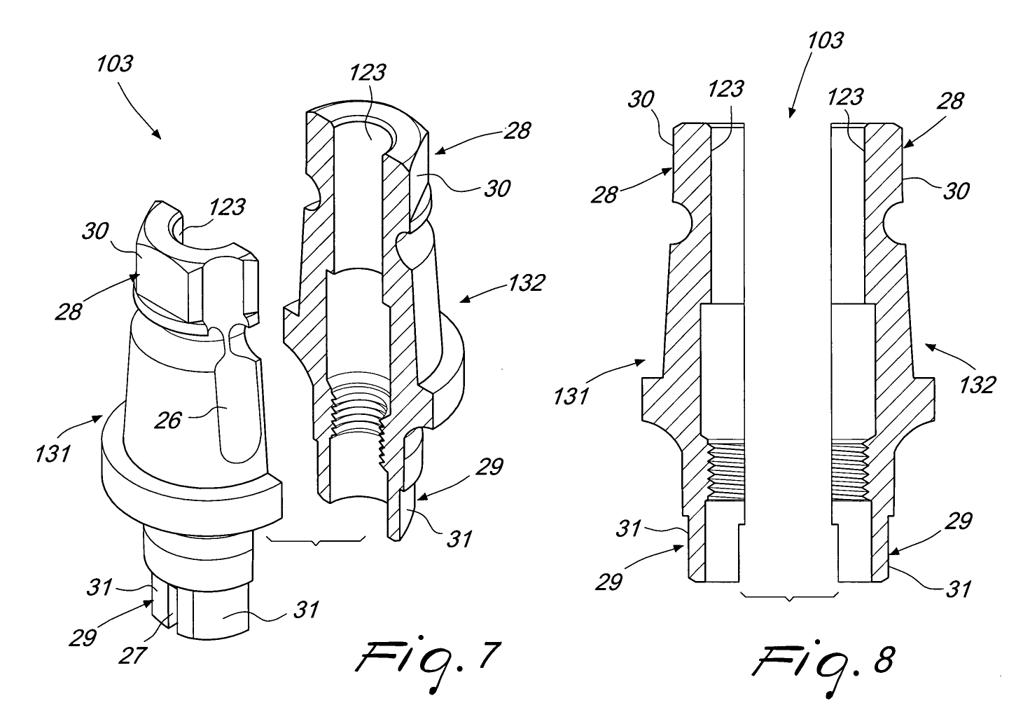

FIG. 7 is an exploded perspective view of a variation of the stump pin in two parts;

FIG. 8 is a sectional view of the stump pin of FIG. 7;

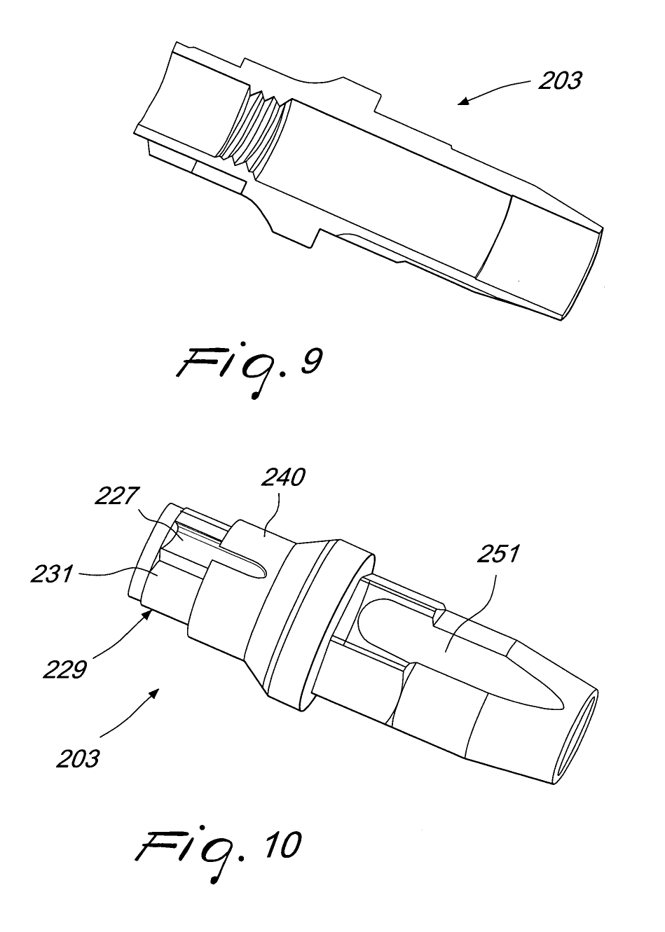

FIG. 9 is a longitudinally sectional perspective view of another embodiment of the stump pin;

FIG. 10 is a perspective view of the stump pin of the preceding figure;

FIG. 11 is a perspective view of the fixing support that can be associated with the stump pin of the preceding figure;

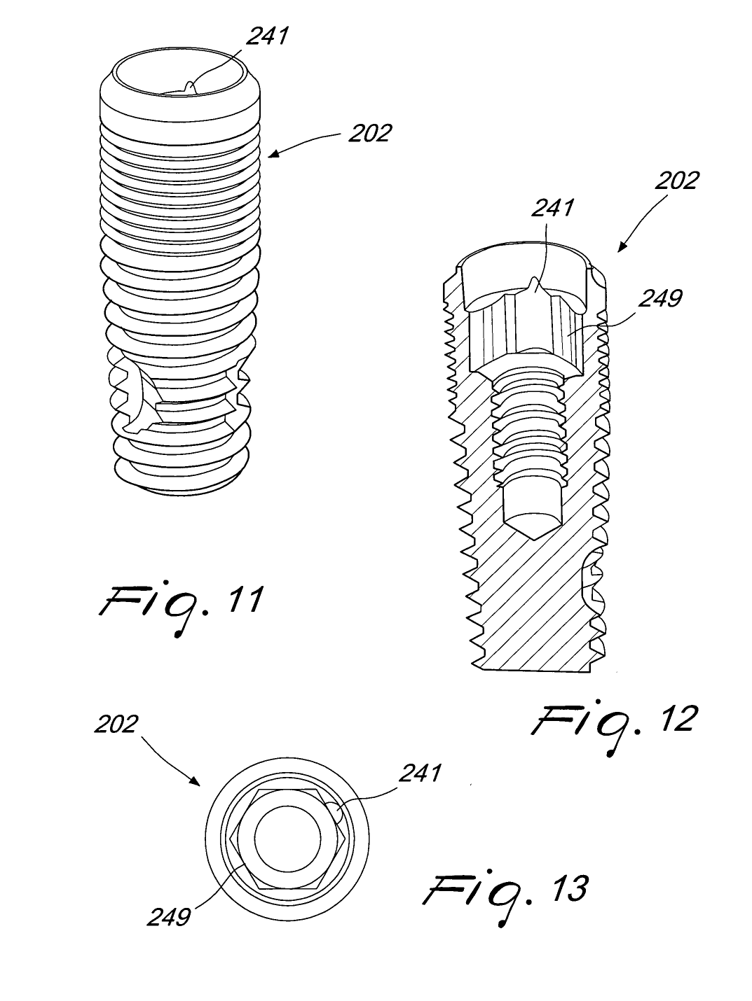

FIG. 12 is a longitudinally sectional perspective view of the fixing support of the preceding figure;

FIG. 13 is a plan view of the support of the preceding figure.

With reference to the cited figures, the implant, according to the invention, for fixing dental prostheses such as crowns, bridges or dentures, generally designated by the reference numeral 1, includes a fixing support 2, a stump pin 3 and a cap 4.

The fixing support 2 is constituted by an elongated member having a length comprised between approximately 5 mm and approximately 20 mm and having a diameter comprised between approximately 3 mm and approximately 7 mm.

Preferably, the support 2 is made of titanium or of a titanium-based alloy or of any biocompatible and osteointegratable material made of metal alloy, ceramic or other materials.

The support 2 has a first crown portion 5, which lies in the part of the support that is located between the gum and the first part of the jawbone, and a second apex portion 6, which lies within the jawbone.

The crown portion 5 is preferably substantially cylindrical, while the apex portion 6 is preferably frustum-shaped and ends with a free end 7.

The frustum-shaped portion 6 of the support 2 is provided with a sharp thread 8.

In order to prevent the support from unscrewing during the life of the implant 1, due to the stress caused by mastication, at least one rotation-preventing slot 9 is provided in the frustum-shaped portion 6.

Each rotation-preventing slot 9 has a sharp side that is directed in the opposite direction with respect to the screwing direction of the support, so as to contrast the tendency to unscrewing that occurs directly after insertion of the support.

Therefore, the longitudinal slots ensure initial stability of the implant.

Each slot extends from the apex of the implant for at least 2-7 mm, according to the size of the implant, and has a depth, with respect to the body of the frustum-shaped portion 6, of at least 0.2 mm-1.5 mm depending on the diameter of the implant.

The slot also has the function of facilitating any forced removal of the implant by virtue of the action of its sharp side on bone trabeculae.

The start 10 of the sharp thread 8 is arranged at the free end of the frustum-shaped portion 6 and is suitable to cut into the jawbone.

The cylindrical portion 5 is at least partially provided with a notched region 11 constituted by annular ridges.

The annular ridges are preferably shaped like a micro-thread that is adjacent to the thread of the frustum-shaped portion.

The micro-thread preferably has a sharp shape, so as to minimize trauma during insertion in the jawbone.

According to a preferred embodiment, the micro-thread 11 has a height comprised between 0.1 and 0.8 mm.

The number of threads can vary and is comprised preferably between 1 and 8. The micro-thread preferably has the same pitch as the thread 10 but with a multiple number of screw starts, so as to screw exactly in step with the thread 11.

The micro-thread 11 allows to better transfer the forces generated by mastication between the implant and the surrounding bone; such forces would otherwise generate shear stresses that would not be well tolerated by the bone.

Preferably, the pitch of the micro-thread, i.e., the distance between two crests, is approximately twice the height of the thread in order to screw in without causing dangerous friction.

The upper edge 12 of the support is cut obliquely with a radius that gives it a concave rounded shape.

The support 2 is screwed into a cavity to be prepared specifically in the jawbone of the patient, where the part of the cylindrical portion that is not provided with a micro-thread emerges beyond the crest of the bone or is inserted flush with respect to the crest or up to 1 mm below said bone crest.

In the side of the support 2 that is directed toward the oral cavity there is the stump pin 3, which is suitable for fixing the prostheses.

The support and the stump pin can be provided monolithically, or, as shown in the figures, in two separate bodies. In both cases, the cross-section of the implant in the connecting region between the support 2 and the stump pin 3 tapers in order to form a recessed region 13. The recessed region 13, if arranged slightly above the crest of the jawbone, is suitable to accommodate and stop the surrounding gum in a preset position, keeping as such, or as constant as possible, the level of the gum even in case of retraction or recession of the bone.

Preferably, the support 2 and the stump pin 3 are constituted by two separate bodies that can be assembled, wherein a positioning means, for example of the type described in Italian patent application No. GE2005A000069, included herein by reference, allows to position the stump pin 3 with respect to the support 2 in a unambiguous, preset and repeatable manner. A receptacle 14 is provided in the support 2, from the side directed toward the oral cavity in the direction of the free end 7. The receptacle 14 is frustum-shaped, with a taper comprised between 0.5 and 2° and tapers in the direction of the free end 7 of the support 2. A first part 15 of the stump pin 3 is inserted in the receptacle and has a shape that is substantially complementary with respect to the receptacle 14. The stump pin 3 is provided longitudinally, in one of the embodiments, with a substantially central through hole 16, seen from the end that is arranged in the receptacle 14 toward the oral cavity, and has a first thread passage portion 17 that has a larger diameter than the stem 18 of a screw 19 and a smaller diameter than the head 20 of the screw 19.

The stump pin 3 has a second accommodation portion 21, whose cross-section is at least slightly larger than the head 20 of the screw 19. The head 20 of the screw 19 is accommodated in the second accommodation portion 21 and the stem 18 of the screw 19 passes through the first passage portion 17 and is engaged in a corresponding threaded hole 22 that is formed in the support 2 starting from the base of the receptacle 14 in the direction of the free end 7 of the support 2.

The through hole 16 has a third extraction portion 23, which follows the second accommodation portion 21 on the opposite side with respect to the first passage portion 17. This third portion 23 has a reduced cross-section with respect to the second accommodation portion 21 and has a cross-section that is at least partly smaller than that of the head 20 of the screw 19.

The screw is longer than the overall length of the two passage and accommodation portions 17, 21. In this manner, by unscrewing it, the screw acts as an extractor for the stump pin 3 and is capable of separating the stump pin 3 from the support 2.

Preferably, the third extraction portion 23 is constituted by a hollow cylindrical member 25, which is arranged in the hole that constitutes the second portion 21, and the inside diameter of the cavity of the hollow cylindrical member 25 is such as to allow to insert a tool, such as a screwdriver or the like, for screwing and unscrewing the screw. This hollow cylindrical member 25 can be fastened to the stump pin 3, for example by means of complementary threads provided on the internal wall of the stump pin 3 and on the outer surface of the member 25 or bonded by adhesive or welded.

As an alternative, the member 25 can be locked by simply forcing it within the stump pin 3.

According to a further aspect of the invention, shown in FIGS. 7 and 8, the third extraction portion 123 is formed by the wall of the stump pin 103. In this case, in order to be able to insert the screw 19 in the through hole, the body of the stump pin 103 is constituted by two halves 131 and 132 that can be assembled and that would be obtained if the body of the stump 3 were divided longitudinally, obliquely or transversely with interlocking or welding.

According to a further aspect of the invention, the stump is made of a magnetic alloy, thus avoiding the need to cement the cap 4 in order to fasten it. As an alternative, it is possible to provide the hollow cylindrical member by using magnetic material so that the cap 4 stays in the desired position with respect to the stump pin 3 by means of the magnetic attraction.

The part of the stump pin 3 that protrudes from the receptacle 14 of the support 2, in the direction of the oral cavity of the patient, has, with respect to the part of the cylindrical portion 5 of the support 2, a smaller cross-section that widens in the direction of its free end in order to form the recessed region 13 as the receptacle for the jaw. The cap 4 is fitted on the end of the stump pin that protrudes beyond the gum in the oral cavity of the patient, and for this purpose has an internal shape that is substantially complementary to the free end of the stump pin 3.

Preferably, the receptacle 14, and the outer wall of the part of the stump pin that is inserted in the receptacle, also include a mutual engagement means 27, 29, 31, which aligns the stump pin 3 with respect to the support 2 in an unambiguous, preset and repeatable manner. The cap and the part of the stump on which the cap is fitted also include a mutual engagement means 26, 28, 30, which aligns the cap 4 with respect to the stump pin 3 in an unambiguous, preset and repeatable manner. The mutual engagement means 26-31 can be the one described in Italian patent application No. GE2005A000069.

Preferably, the mutual engagement means is constituted by at least one slot 27 provided longitudinally in the wall of the part of the stump, be it conical, hexagonal or polygonal, that is inserted in the receptacle of the support, where on the wall of the receptacle there is a complementary guiding fin suitable to engage in the slot of the stump pin. The slot 27 also has another function: it gives elasticity to the rigid parts of the hexagon and of the cone. It can be used, therefore, to facilitate the extraction of impression devices that are not mutually parallel.

In the constructive example of FIGS. 9-13, the mutual engagement means is constituted by a tooth 227, as described further on in greater detail.

At least one slot 26 is formed longitudinally also in the wall of the part of the stump pin on which the cap is fitted. Correspondingly, at least one complementary guiding fin, suitable to engage in the slot, is formed on the internal wall of the cap.

The end of the part of the stump pin 3 that is inserted in the receptacle 14 has a contoured profile 29, and in the receptacle 14 there is a complementary contoured profile in order to accommodate the contoured profile end of the stump pin 3.

Preferably, the stump pin, in the region of the end inserted in the receptacle, where the contoured profile is formed, has a cross-section that is substantially hexagonal or polygonal or formed by slots, fins or teeth, depending on the diameters of the various embodiments, on the diameters and on the construction requirements.

A contoured profile 28 is provided also at the end of the stump pin 3 that is directed toward the oral cavity and correspondingly in the cap 4 there is a complementary contoured profile.

Preferably, the stump pin has a substantially hexagonal cross-section in the region where the contoured profile is formed. The six sides 31 of the hexagonal profile 29, formed at the end inserted in the receptacle of the support, or otherwise the sides of a polygon, are arranged in step with the six sides 30 of the hexagonal profile 28 or with the sides of the polygon of the end that is directed toward the oral cavity of the patient. The same applies in the case of profiles contoured with other geometric shapes, which are arranged in step in order to ensure repeatable mating.

According to an aspect of the present invention, the implant, shown in FIGS. 9-13, has a mating between the fixing support 202 and the stump pin 203 that is constituted both by a cone 240 and by a hexagon 229 in order to have the advantages both of the cone and of the hexagon, and can be fixed or not by the through screw.

The hexagonal stump 203 is mated to the support 202 by inserting the stamp into the support in six different positions.

The hexagon 229 works only to provide a position and prevent lateral oscillation, while friction mating is provided by the cone, which mates with maximum precision.

The hexagon 229 of the stump 203 has a tooth 227 at the center of a face 231 of the hexagon, which mates with a slot 241 in a face of the internal hexagon 249 of the support 202 that gives it an unambiguous position.

The hexagon 249 of the support 202 is in step with the hexagon 229 of the stump 203.

One face of the hexagon 229 of the stump 203 is in step with the ring of the stump.

The tooth 227 is in step with the slot 141 of the support 202 and with the ring 251 of the stump 203.

The tooth 227 provides the stump with an easy and smooth insertion, because the sides of the hexagon do not mate until the tooth is in the correct receptacle.

The implant includes a safety system, in which the through screw cannot screw in if the tooth is not inserted in the correct receptacle.

The stump, formed in two parts, traps the through screw, which cannot fall.

The stump, formed in two parts, traps the through screw, which acts as an extractor for the stump which, if mated, would be difficult to extract.

In stumps that are inclined, that can be cast or that are bases for casting in place, where it is impossible to build the stump in two parts, an appropriately provided extractor, which is built separately, or a movable or detachable lateral pin or a hole for the insertion of an appropriately provided grub, facilitates its removal.

The extractor cylinder can be fastened by pressing but can also be glued or screwed by means of an adapted thread.

The hexagon of the stump can be divided into two parts and can be activated manually or by the through screw in order to increase friction on the walls of the implant. The same hexagon, divided into two parts and applied to an impression pin, facilitates its passive removal in one or more teeth provided inside the implant.

The stump has an internal thread, so as to prevent the through screw from falling also when the extractor cylinder is not present.

The stump has an internal thread for the insertion of an appropriately provided external screw extractor to remove the stumps mated with the implant.

The extractor is an accessory provided in the user kit of the prosthetic components of the implant.

In practice it has been found that the invention achieves the intended aim and objects, providing an implant for fixing dental prostheses, such as for example dental crowns, bridges or dentures, as a replacement of one or more fallen teeth, that overcomes the drawbacks noted above.

This application claims the priority of Italian Patent Application No. GE2008A000054, filed on Jun. 11, 2008, the subject matter of which is incorporated herein by reference.

The following list of claims replaces any prior listing of claims:

1. An implant for fixing dental prostheses, such as dental crowns, bridges, dentures or the like, comprising a support that is suitable to be screwed into a receptacle prepared in the jawbone so as to have a free end, a stump pin that is associated with said free end in order to support said prostheses, wherein said support comprises at least two portions: an apex portion, provided with a thread suitable to penetrate into the jawbone, and a crown portion, provided with annular micro-notches or a narrower thread wherein the implant is provided internally, for its connection to the stump, with a cone, a hexagon of the implant and a ring or tooth or slot that gives it, if needed, an unambiguous position but does not prevent the insertion of stumps with conical or conical-hexagonal mating; a through screw, which can be tightened with optimum torque, allows to fix the stump to the correct mating, using the thread formed inside the stump and the implant.

2.-22. (canceled)

23. The implant according to claim 1, characterized in that the hexagon of the stump has a tooth at the center of a face of the hexagon that mates with a slot in a face of the internal hexagon of the implant that gives it an unambiguous position.

24.-25. (canceled)

26. The implant according to claim 23, wherein the tooth can be male or female.

27. The implant according to claim 1, wherein the tooth provides the stump with a simple and smooth insertion because the sides of the hexagon do not mate until the tooth is in the correct receptacle.

28. The implant according to claim 1, wherein the implant comprises a safety system in which the through screw does not screw in if the tooth is not inserted in the correct receptacle.

29. The implant according to claim 1, wherein the stump formed in two parts traps a through screw that cannot fall.

30. The implant according to claim 29, wherein the stump built in two parts traps a through screw that acts as an extractor for the stump, which if mated would be difficult to extract.

31. The implant according to claim 30, wherein, in stumps that are inclined or can be cast or are bases for casting in place, where it is impossible to build the stump in two parts, a movable or removable lateral pin or a hole for the insertion of an appropriately provided grub facilitates its removal.

32. The implant according to claim 31, wherein the extractor cylinder can be fixed by pressing but can also be bonded by means of adhesive, screwed by means of an appropriately provided thread.

33.-34. (canceled)

35. The implant according to claim 32, wherein the stump has an internal thread for the insertion of an appropriately provided external screw-type extractor for removing the stumps mated with the implant.

36. The implant according to claim 35, wherein the extractor is an accessory provided in the user kit of the prosthetic components of the implant.
